(19) United States
(12) Patent Application Publication
(10) Pub. No.: US 2020/0190780 A1
(43) Pub. Date: Jun. 18, 2020

(54) BATHTUB DRAIN SYSTEM WITH CONTROLLABLE THREE-WAY VALVE

(71) Applicant: CG AIR SYSTEMES INC., Ste-Marguerite (CA)

(72) Inventors: MIGUEL A. CASTELLOTE, FRAMPTON (CA); DOMINIQUE CIECHANOWSKI, FRAMPTON (CA)

(21) Appl. No.: 16/718,336

(22) Filed: Dec. 18, 2019

Related U.S. Application Data
(60) Provisional application No. 62/781,083, filed on Dec. 18, 2018.

(51) Int. Cl. E03C 1/122; E03C 1/22; F16K 11/08

(52) U.S. Cl. CPC E03C 1/1227; A47K 3/006; F16K 11/08; E03C 1/22

(57) ABSTRACT

Known walk-in bathtubs with doors typically use two dedicated pumps to help quickly empty the bathtub. Because space is limited under such bathtubs, the use of two pumps takes up a lot of the available space and is relatively expensive. According to the invention, there is provided a drain system for use with a walk-in bathtub that only requires one pump. The system includes: a motorized pump; and a controllable three-way valve having: an inlet for receiving fluid; a first outlet operatively connectable to the motorized pump for generating a whirlpool in the bathtub; and a second outlet operatively connectable to the motorized pump for pumping fluid out of the bathtub.

### CROSS REFERENCE TO RELATED APPLICATION

This application claims benefit, under 35 U.S.C. § 119(e), of U.S. provisional application Ser. No. 62/781,083, filed on Dec. 17, 2018, which is incorporated herein in its entirety by reference.

### FIELD OF THE INVENTION

The present invention generally relates to drain systems for bathtubs, and more particularly to bathtubs of the type having doors (i.e., walk-in bathtub) that provide an access to an interior of the bathtub.

### BACKGROUND OF THE INVENTION

Bathtubs with doors are an increasingly common occurrence in households. They are used to facilitate entrance into the tub for the physically challenged, such as elderly and/or disabled users. Accordingly, such users do not need to step over the bathtub wall to enter the tub.

However, because of their depth, walk-in bathtubs hold very large volumes of water. With seat heights approaching 17 inches (43 cm) above the tub floor water volume can reach 70 gallons (265 L) or more. Typically, such large volumes require several minutes to drain from the tub. This is particularly troublesome in the case of walk-in bathtubs because the occupant cannot open the side door and exit the tub until the water has drained, especially in models in which the side door opens to the inside and is held shut by water pressure.

Therefore, in the field of bathtubs, especially bathtubs with doors, with the user's comfort in mind, the standard is to proceed with a quick filling of the bath and a quick emptying thereof.

In this context, some manufacturers of walk-in baths use a second dedicated pump to help empty the bathtub. For example, US Patent Publication No. 2012/0324644A2 (by Neidich et al.) discloses a drain system for a walk-in bathtub 10 with a door 11 (shown in FIG. 1) and on/off button 12 for activating a whirlpool pump 13 (shown in FIG. 2). Referring to FIG. 2, there is shown the plumbing of a suction drain in accordance with this known system. This equipment is placed under the seat and support frame 14 of the walk-in bathtub. A suction pipe 15 draws water through a dedicated outlet in the foot well of the bathtub. Suction is provided by a dedicated motorized drain pump 16. Rather than relying solely on gravity to empty the bathtub, the dedicated drain pump 16 pumps water out of the bathtub 10 and redirects it via an outlet suction pipe 17 to a building's main drain. This quicker emptying of the bathtub 10 allows a user to wait less time in the bathtub before being able to open the door and exit, since the water must be completely drained before the door opens.

Because space is limited under such bathtubs, the use of two pumps takes up a lot of the available space, especially considering that these are not usually the only components. Indeed, further to the pumps, there is often an air blower, an ozonator, an electronic control, etc. The cost of a second pump is relatively expensive and installing a second pump on such bathtub can take a relatively long time. Furthermore, an additional pump usually requires an extra power line, which is also relatively more expensive.

### SUMMARY OF THE INVENTION

In order to address the above and other drawbacks, there is provided a drain system for use with a walk-in bathtub, comprising: a motorized pump; and a controllable three-way valve including: an inlet for receiving fluid; a first outlet operatively connectable to the motorized pump for generating a whirlpool in the bathtub; a second outlet operatively connectable to the motorized pump for pumping fluid out of the bathtub.

In an embodiment, the controllable three-way valve is electronically operated by means of an electromechanical actuator for operating the three-way valve between a first mode where the inlet is operatively connected to the first outlet and a second mode where the inlet is operatively connected to the second outlet.

In an embodiment, the controllable three-way valve is operated by means of a mechanical actuator.

In embodiments, the three-way valve has a T or Y configurations.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 is a perspective view of a known walk-in bathtub in accordance with the prior art;

FIG. 2 is a perspective view of the plumbing of the suction drain of the known walk-in bathtub shown in FIG. 1;

FIGS. 3A to 3D are respectively top, perspective, front and right side views of a three-way valve, in accordance with a first illustrative embodiment of the present invention;

FIGS. 4A to 4D are respectively top, perspective, front and right side views of a three-way valve, in accordance with a second illustrative embodiment of the present invention;

FIGS. 5A to 5D are respectively top, perspective, front and right side views of a three-way valve, in accordance with a third illustrative embodiment of the present invention;

FIGS. 6A to 6D are respectively top, perspective, front and right side views of a three-way valve, in accordance with a fourth illustrative embodiment of the present invention;

FIGS. 7A to 7D are respectively top, perspective, front and right side views of a three-way valve, in accordance with a fifth illustrative embodiment of the present invention; and

FIGS. 8A to 8D are respectively top, perspective, front and right side views of a three-way valve, in accordance with a sixth illustrative embodiment of the present invention.

### DESCRIPTION OF ILLUSTRATIVE EMBODIMENTS

The present invention is illustrated in further details by the following non-limiting examples.

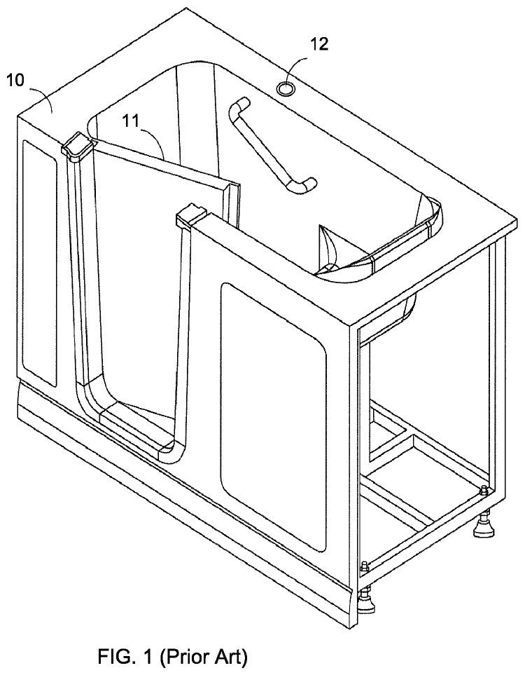

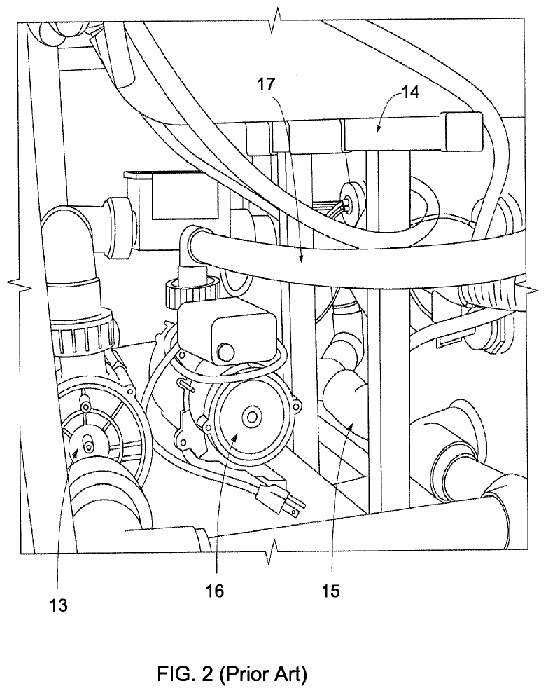

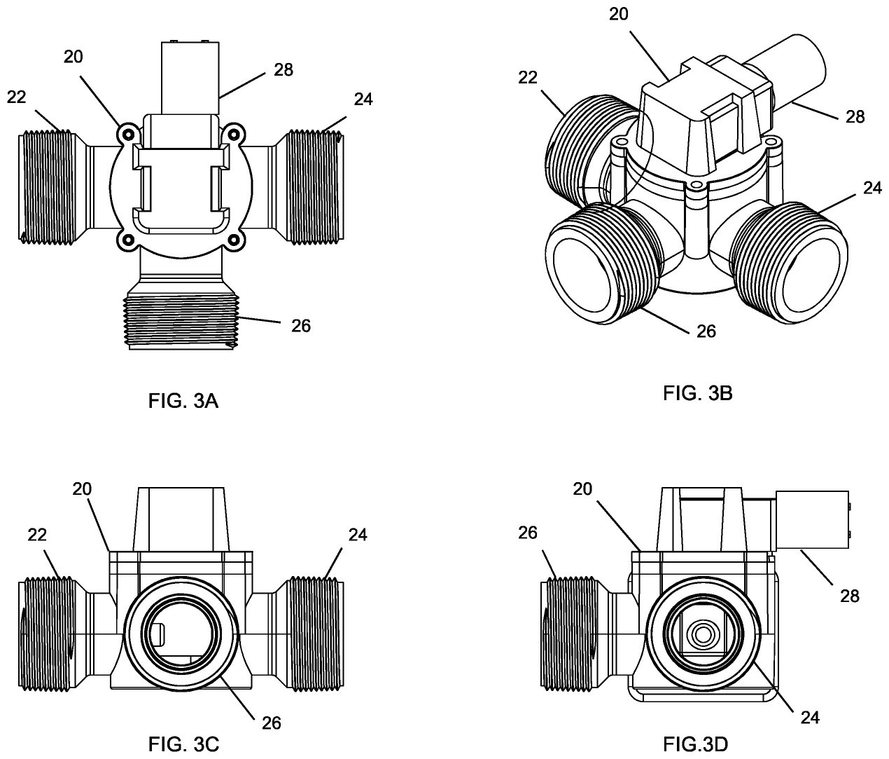

Referring back to FIGS. 1 and 2, the known walk-in bathtub 10 uses the whirlpool pump 13 for generating whirlpools in the bathtub 10. However, according to the present system, instead of using the second pump 16, a controllable three-way valve 20 (shown in FIGS. 3A to 8D) is used to accomplish both functions of generating whirlpools in the bathtub and draining the bathtub.

Referring now to FIGS. 3A to 3D, there is shown a controllable three-way valve 20 in a T configuration according to a first preferred embodiment. The three-way valve 20 includes an inlet 22 for receiving fluid coming from the bathtub 10. The three-way valve 20 includes a first outlet 24 operatively connectable to the existing motorized whirlpool pump 13 for generating a whirlpool in the bathtub 10. The three-way valve 20 includes a second outlet 26 operatively connectable to the motorized pump 13 for draining fluid out of the bathtub. In the first embodiment, the controllable three-way valve 20 includes an electromechanical actuator 28 for operating the three-way valve 20 between a first mode where the inlet 22 is operatively connected to the first outlet 24 and a second mode where the inlet 22 is operatively connected to the second outlet 26.

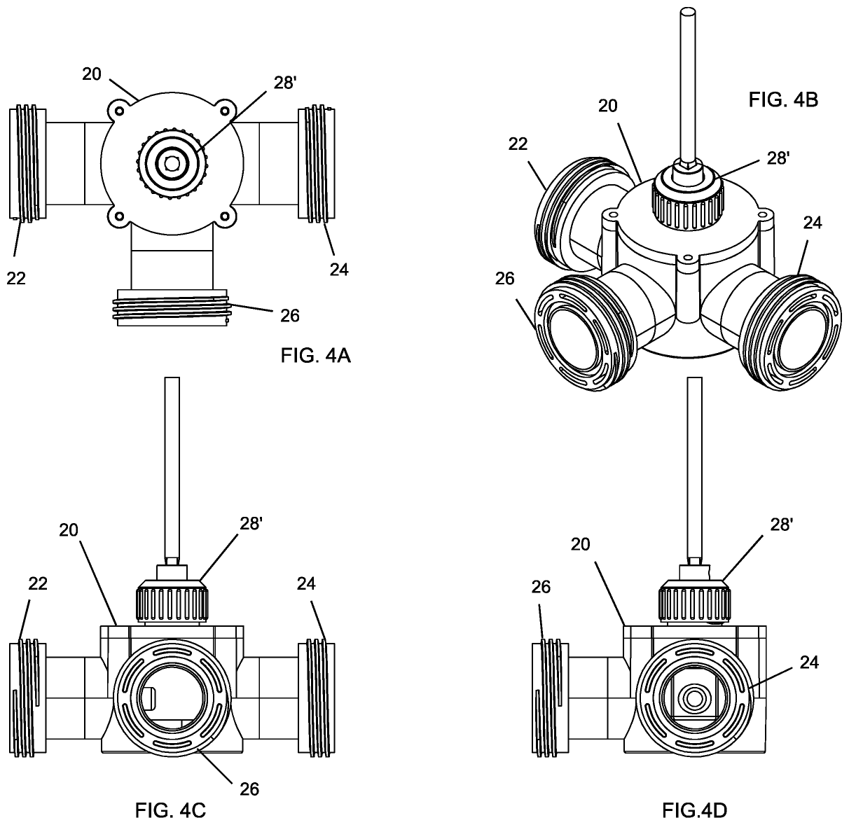

Referring now to FIGS. 4A to 4D, there is shown a controllable three-way valve 20 in a T configuration according to a second preferred embodiment. The three-way valve 20 is similar to the one shown in FIGS. 3A to 3D with the electromechanical actuator 28, but it has been replaced with a mechanical actuator 28′ having a rod extending therefrom.

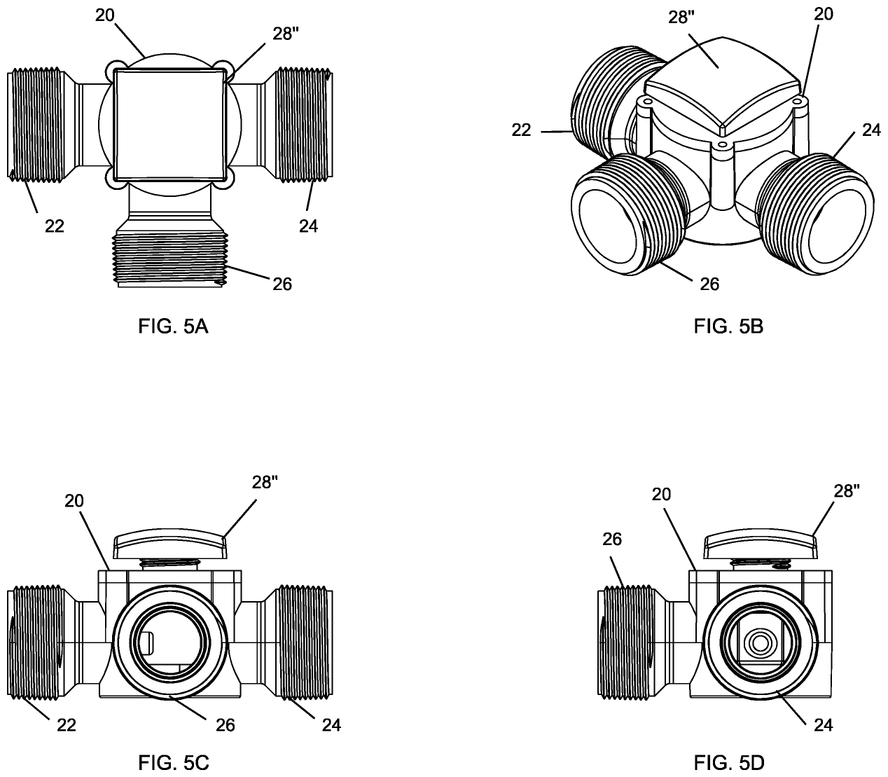

Referring now to FIGS. 5A to 5D, there is shown a controllable three-way valve 20 in a T configuration according to a third preferred embodiment. The three-way valve 20 is similar to the one shown in FIGS. 3A to 3D with the electromechanical actuator 28, but it has been replaced with another type of mechanical actuator 28″ having a handle portion extending therefrom.

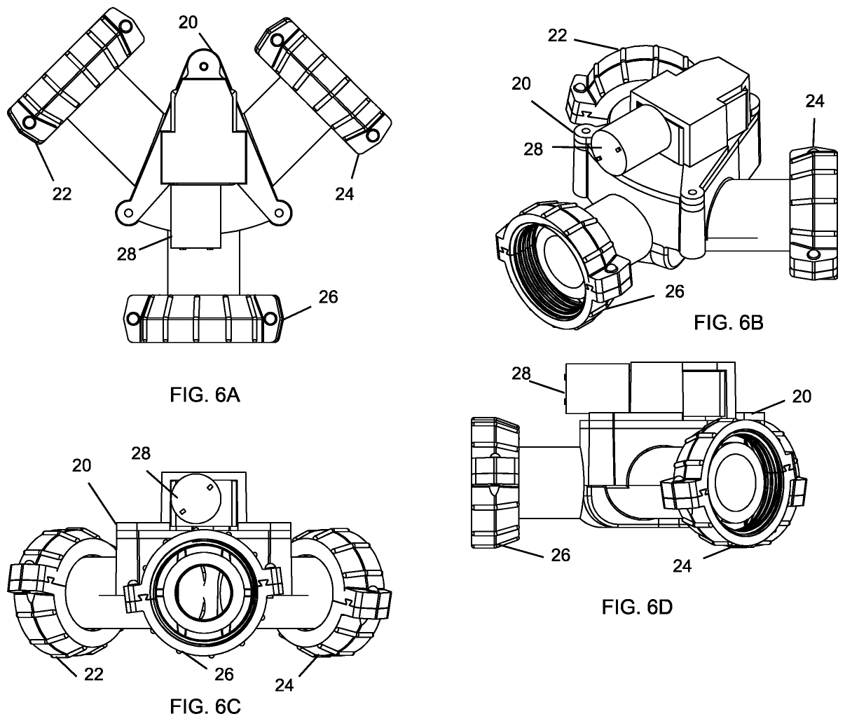

Referring now to FIGS. 6A to 6D, there is shown a controllable three-way valve 20 in a Y configuration according to a fourth preferred embodiment. The three-way valve 20 is similar to the one shown in FIGS. 3A to 3D having the electromechanical actuator 28.

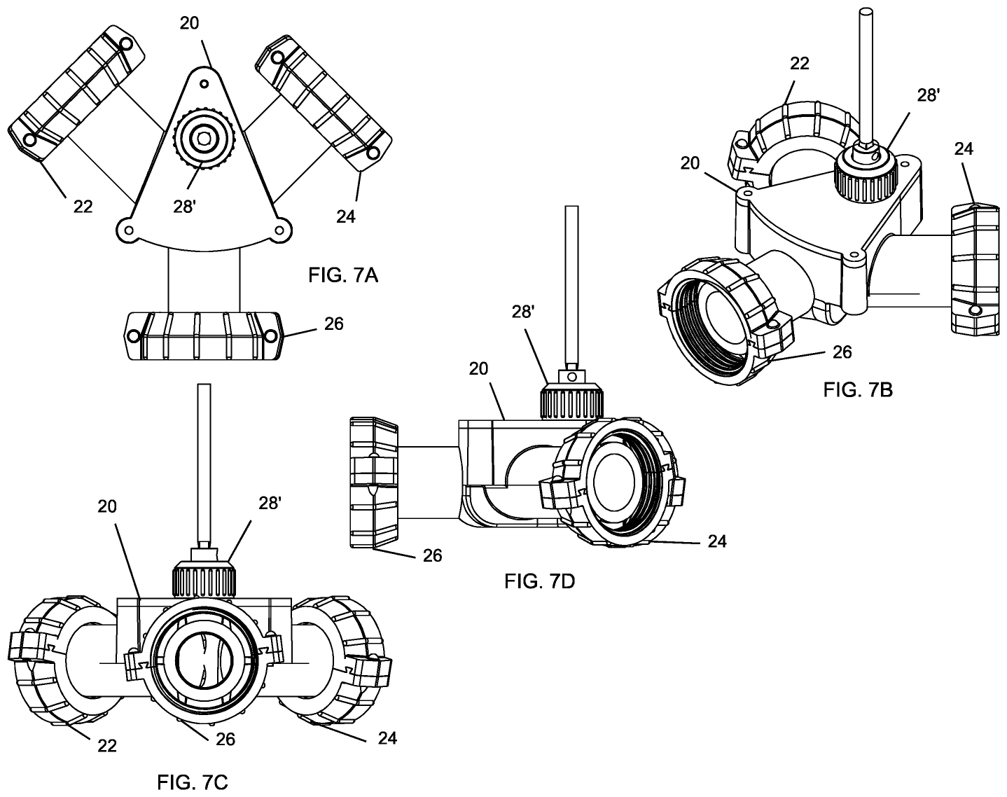

Referring now to FIGS. 7A to 7D, there is shown a controllable three-way valve 20 in a Y configuration according to a fifth preferred embodiment. The three-way valve 20 is similar to the one shown in FIGS. 6A to 6D with the electromechanical actuator 28, but it has been replaced with a mechanical actuator 28′ having a rod extending therefrom.

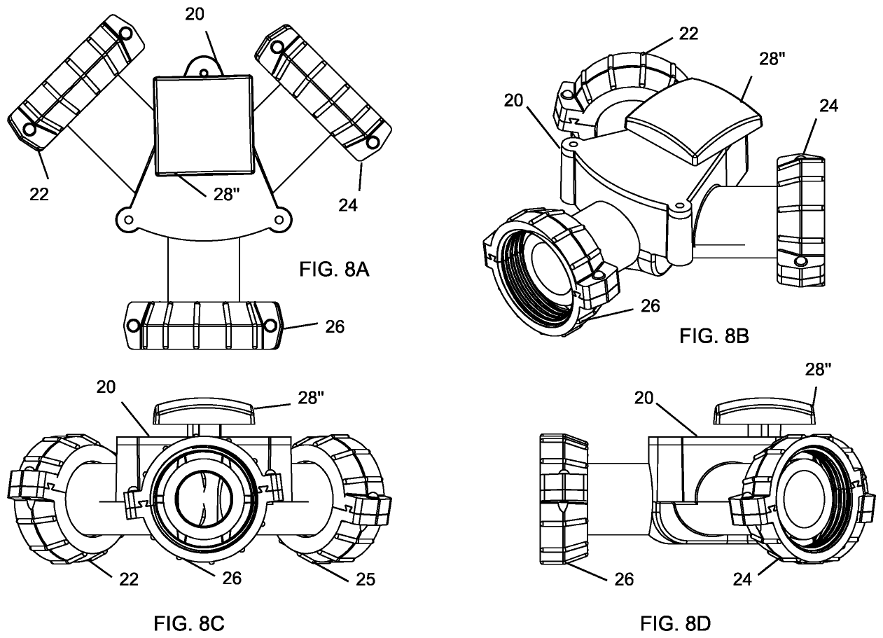

Referring now to FIGS. 8A to 8D, there is shown a controllable three-way valve 20 in a Y configuration according to a sixth preferred embodiment. The three-way valve 20 is similar to the one shown in FIGS. 6A to 6D with the electromechanical actuator 28, but it has been replaced with another type of mechanical actuator 28″ having a handle portion extending therefrom.

Advantageously, in the first and fourth embodiments, the three-way controllable valve 20 may be controlled by an electronically controlled motor or electromechanical actuator 28 using a keyboard.

Alternatively, the three-way controllable valve 20, as in the second, third, fifth and sixth embodiments, may be controlled by a mechanical actuator 28′, 28″. For example, the valve 20 may be either controlled by a handle directly connected to the valve 20, or by a handle connected to a cable (such as those for drains or bicycle brakes) attached to the valve 20.

In use, when the three-way valve 20 is in “whirlpool mode” or “whirlpool position”, the valve 20 completely seals the outlet 26 to the drain, completely opens the outlet 24 to the jets and the user can enjoy a whirlpool massage. When in the “drain mode” or “drain position”, the valve 20 completely seals the outlet 24 to the jets, completely opens the outlet 26 to the drain and the user benefits from faster drainage than by gravity alone.

It is to be noted that the standard (gravity) drain can also be used in conjunction with the “drain mode” of the valve 20.

Advantageously, the present drain system uses a three-way valve instead of a second pump as in the known drain systems described in the above prior art section. By doing so, the space requirement is greatly reduced because the three-way valve can be installed at different locations with a footprint that is much smaller than for a pump. Furthermore, the installation time of a three-way valve in a walk-in bathtub with an existing whirlpool pump is much faster than the time required to install a second dedicated drain pump in such walk-in bathtub.

Advantageously, the present drain system uses a single pump for both functions of generating a whirlpool and draining the bathtub.

The scope of the claims should not be limited by the preferred embodiments set forth in the examples, but should be given the broadest interpretation consistent with the description as a whole.

1. A drain system for use with a walk-in bathtub, comprising:
a motorized pump (13); and
a controllable three-way valve (20) including:
an inlet (22) for receiving fluid;
a first outlet (24) operatively connectable to the motorized pump (13) for generating a whirlpool in the bathtub; and
a second outlet (26) operatively connectable to the motorized pump (13) for draining fluid out of the bathtub.

2. The system of claim 1, wherein said controllable three-way valve (20) comprises an electromechanical actuator (28) for operating said three-way valve (20) between a first mode where the inlet (22) is operatively connected to the first outlet (24) and a second mode where the inlet (22) is operatively connected to the second outlet (26).

3. The system of claim 1, wherein said controllable three-way valve (22) comprises a mechanical actuator (28′, 28″) for operating said three-way valve (22) between a first position where the inlet (22) is operatively connected to the first outlet (24) and a second position where the inlet (22) is operatively connected to the second outlet (26).

4. The system of claim 1, wherein said controllable three-way valve (20) has a T configuration.

5. The device of claim 1, wherein said controllable three-way valve (20) has a Y configuration.
